(19) United States
(12) Patent Application Publication
(10) Pub. No.: US 2009/0083566 A1
(43) Pub. Date: Mar. 26, 2009

(54) Method and System for Using Meta-Information to Manage Data Object Synchronization

(76) Inventors: Karen N. Momenee, Durham, NC (US); David L. Zanter, Durham, NC (US)

Correspondence Address: DILLON & YUDELL LLP, 8911 N. CAPITAL OF TEXAS HWY., SUITE 2110, AUSTIN, TX, 78759, US

(21) Appl. No.: 11/861,596

(22) Filed: Sep. 26, 2007

(51) Int. Cl. G06F 1/12

(52) U.S. Cl. 713/400

(57) ABSTRACT

A system and method for synchronizing data items in a data processing system. In one embodiment, the method includes receiving a synchronization request that specifies a set of data items that are subject to synchronization. The set of data items subject to synchronization are identified from the synchronization request and a synchronization cycle of the identified set of data items is commenced. The synchronization cycle includes a step of processing meta-information associated with the identified set of data items. Synchronization filter parameters are determined from the processed meta-information and the data items to be synchronized are selected in accordance with the determined synchronization filter parameters.

### BACKGROUND OF THE INVENTION

1. Technical Field

The present invention relates generally to data synchronization and in particular to a method and system for using meta-information to manage synchronization of data objects.

2. Description of the Related Art

Known methods for performing filtering in a synchronization environment typically include using a well-formed, specialized grammar for describing the filtering process. Such a filter control grammar may be implemented as a string of bit-wise operations or a LISP style syntax. The grammar string is either entered into a profile on the server-side or generated on the client and subsequently sent to the server. In either case, the grammar string is parsed and then utilized during the synchronization process to filter the desired data to select which objects are subject to synchronization for a given synchronization cycle.

One of the drawbacks of this known method is that when the entire grammar is defined as one large string for global filtering processes, a modification to one of the sub-parts of the filter grammar string requires either the filter be entirely reconstructed or that the targeted filter string be parsed and modified to insert the required modification. Difficulties with global grammar string modification are further compounded in synchronization environments in which the filtering string used for managing the synchronization process may be independently modified by multiple systems and sites. For example, in a client-server environment, if the client and server are both able to modify the grammar string filtering mechanism, a conflict resolution mechanism would be needed for merging competing or otherwise inconsistent filter modifications.

### SUMMARY OF THE INVENTION

A system and method for synchronizing data items in a data processing system are disclosed herein. In one embodiment, the method includes receiving a synchronization request that specifies a set of data items that are subject to synchronization. The set of data items subject to synchronization are identified from the synchronization request and a synchronization cycle of the identified set of data items is commenced. The synchronization cycle includes a step of processing meta-information associated with the identified set of data items. Synchronization filter parameters are determined from the processed meta-information and the data items to be synchronized are selected in accordance with the determined synchronization filter parameters.

The above as well as additional objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a high-level block diagram illustrating a synchronization system in accordance with one embodiment of the invention;

FIG. 2A is a high-level block diagram depicting an e-mail data structure hierarchy in which synchronization may be performed in accordance with the invention;

FIG. 2B illustrates hierarchically embedded meta-information used for synchronization of e-mail data objects in accordance with the invention;

FIG. 3 is a high-level block diagram depicting a synchronization environment in which a common synchronization server provides data synchronization functions for disparate data types received from distinct servers; and

FIG. 4 is a high-level flow diagram illustrating steps performed during synchronization of data objects using synchronization filter meta-information in accordance with the invention.

### DETAILED DESCRIPTION OF ILLUSTRATIVE EMBODIMENT(S)

The present invention is generally directed to filter mechanisms employed during data synchronization. In particular, and as depicted and explained in further detail below with reference to the figures, the synchronization filter mechanism of the present invention is incorporated within extended file attribute data, generally referred to as meta-information or meta data. Implementing filter information within the meta-information of files, directories, data objects, and other data structures, enables improved scalability when implementing and/or modifying synchronization filter directives and policies.

The present invention allows for improvements over known designs by generating, maintaining, and modifying subsets of the filter data as meta-information of data objects subject to synchronization operations. Meta-information is generally extended information that is linked to a file or other data object in addition to the object's raw data. Meta-information defines properties about the data object in question and is often used to represent data modification times, read/write permissions, and other items. The present invention extends the concept of meta-information to be utilized for filtering the data items to be synchronized responsive to a given synchronization request. The meta-filtering-information data can be generated using any type of filtering grammar. During synchronization of the object's raw data, the filtering meta-information is synchronized as well. The meta-information can be stored either as table entries in a relational database or as extended data along with the raw data in the back-end store.

Using the known methods of using a global filter grammar string for data sets comprising thousands or millions of data items, the size of the grammar string could easily become unwieldy, making modifications complex and time consuming operations. By providing filter data that is data item specific, the present invention provides greatly improved filtering scalability that is particularly useful when applied to very large data sets. Furthermore, since the filtering data is associated as meta-information to the data items, all existing methods and processing mechanisms already in place for addressing partial synchronization, failed synchronization, backup, redundancy and conflict resolution would be easily applied to the meta-information.

Since the filter data is stored as meta-information on top of the raw data, modifications to the raw data can be made without affecting the meta-information. Therefore, for example, if the name or the local identifier for a folder changes, the synchronization filter meta-information associated with the folder remains unchanged. This is in contrast to conventional grammar string implementations in which, if the grammar string “syncfolder=‘Folder A’” is stored in the synchronization profile, and if a user renamed Folder A to Folder B, the synchronization filter grammar would need to be changed to “syncfolder=‘Folder B’.”

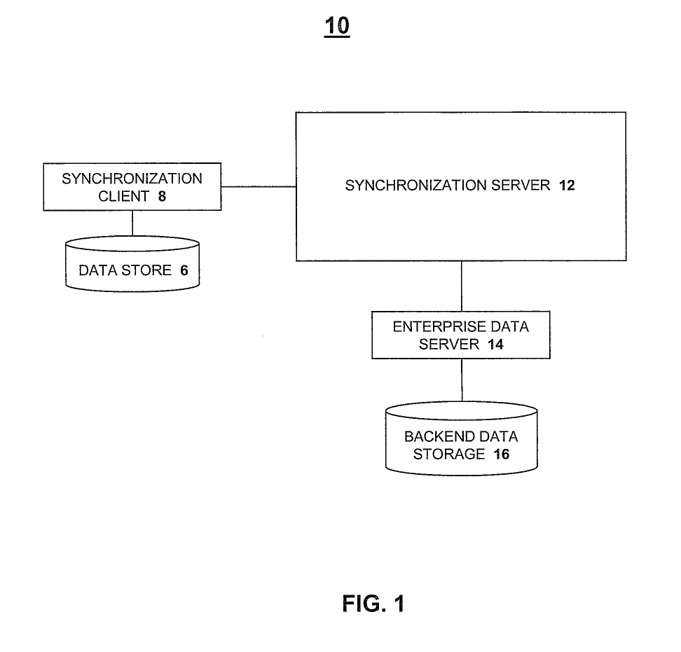

With reference now to the figures wherein like reference numerals refer to like and corresponding parts throughout, and in particular with reference to FIG. 1, there is depicted a high-level block diagram illustrating a synchronization system 10 in accordance with one embodiment of the invention. As shown in FIG. 1, synchronization system 10 generally includes a synchronization server 12 that provides synchronization services between a synchronization client 8 and an enterprise data server 14. Enterprise server 14 is one of multiple possible servers having network-wide data stored within a backend data store 16.

Synchronization client 8 can be a client application on a data processing device having an associated data store 6. Synchronization server 12 may intermittently synchronize data store 6 with data stored by enterprise server 14 within backend data store 16. Accordingly, synchronization client 8 can represent a front-end component that is linked to a backend component via enterprise data server 14. While synchronization client 8 may be any type of application residing on any platform or computing device, it may typically be a component of a regularly updated management application residing on a handheld or other user-specific device such as a personal computer, a personal data assistant (PDA), a mobile telephone, a portable media player, and the like. For example, synchronization client 8 may comprise an e-mail application as well as other personal information manager (PIM) applications for contacts, calendars, and tasks but these are just examples of data types as the invention extends to any data.

Enterprise data server 14 may include a server application on a computing device having associated backend data store 16. Enterprise data server 14 may comprise a standalone application having access to a backend server (not depicted) managing access to backend data store 16 and which provides data services for a networked information system. For example, enterprise data server 14 can include a LOTUS DOMINO server from International Business Machine Corporation (IBM) of Armonk, N.Y., a NOVELL GROUPWISE server from Novell Inc. of Waltham, Mass., and the like.

Enterprise data server 14 can be configured in accordance with a number of different synchronization technologies that permit the data in data store 6 to be bi-directionally synchronized with data in backend data store 16. For example, in different embodiments of the present invention, enterprise data server 14 can include an e-mail server, a PIM server, a relational database server, or other types of bi-directional data servers. The e-mail server (or other type of enterprise data server 14) may be configured to automatically synchronize itself with one or more synchronization clients 8 in accordance with pre-specified or client-specified/modified criteria and settings. Each of the synchronization settings may specify a synchronization level, a synchronization frequency, and other specified synchronization cycle parameters.

Synchronization server 12 can include logic and program instructions and modules that coordinate synchronization operations between synchronization client 8 and enterprise data server 14. Such synchronization logic and instructions may include an enterprise server like a DOMINO EVERYPLACE server from IBM. Synchronization server 12 can also include a small office or desktop server that uses such applications as EASYSYNC from IBM.

Synchronization server 12 can be configured for automatic or manual synchronization operations that are initiated by either synchronization client 8 or enterprise data server 14. Additionally, synchronization server 12 can synchronize multiple synchronization clients 8 with multiple enterprise data servers 14. For example, synchronization server 12 can synchronize a portion of data store 6 with data within backend data store 16 and a different portion of data store 6 with a data store (not shown) associated with a different data server (not shown). Moreover, synchronization server 12 can synchronize synchronization client 8 with multiple data servers simultaneously in a user-transparent manner.

Additionally, synchronization server 12 can be implemented as a centralized computing device or as a group of distributed, communicatively linked computing devices. To provide network connectivity with synchronization clients 8 and enterprise servers 14, synchronization server 12 may include wireline communication ports and wireless transceivers that function as access points for wireless communications. For example, synchronization server 12 may include one or more strategically placed access points in accordance with established protocols, such as the extended service set (ESS) protocol.

The data stores 6 and 16 store information using any volatile or non-volatile data recording medium, such as magnetic and/or optical disks or other media, circuit-based storage, and semiconductor memory. Further, each of data stores 6 and 16 may utilize any information storage management mechanism including any file-based storage or a database storage technique. Moreover, each of data stores 6 and 16 can be a storage area fixed to a geographical location or a storage area distributed across a network space.

It should be appreciated that the configuration shown in FIG. 1 is for illustrative purposes only and that the invention is not limited in this regard. The functionality attributable to the various components can be combined or separated in different manners than those illustrated herein.

One aspect of the present invention is that the meta-information filtering sets are associated with the synchronized data in conformity with the structural hierarchy of the target data items. If the target data items (i.e., set of data items named as an sync command line argument or otherwise specified by a synchronization request) are structured in a hierarchical manner, the filtering data subsets will operate in conformity with the extant hierarchical data structure.

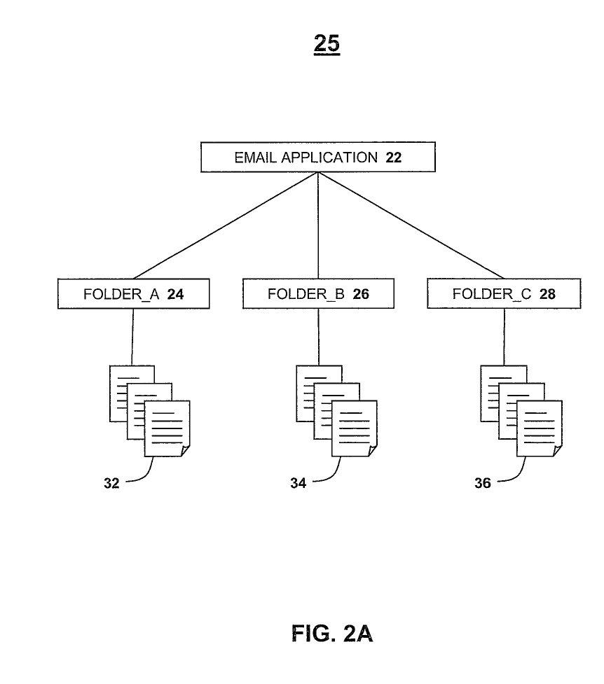

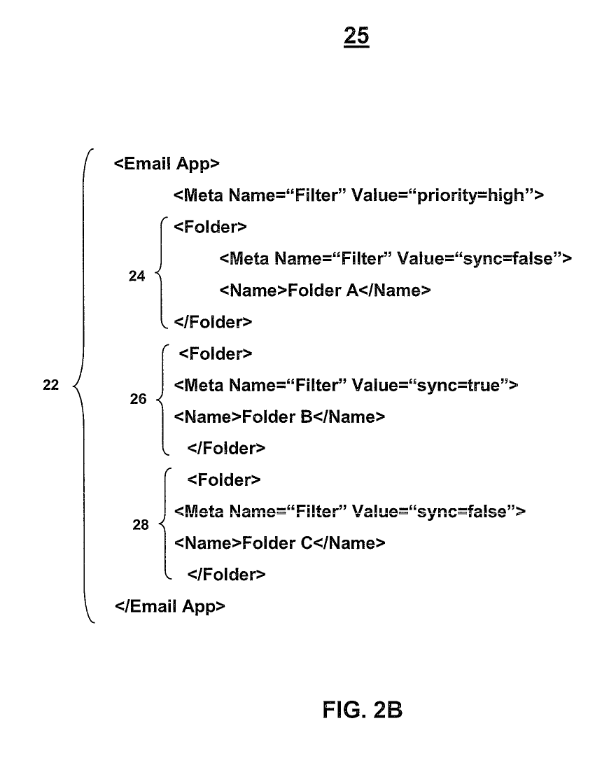

As explained with reference to FIGS. 2A and 2B, the invention can be implemented in a manner that leverages the hierarchical structure in which e-mail data items are arranged in an end user's set of custom e-mail folders. While the set of predefined e-mail folders is small: Inbox, Outbox, Drafts, and Sent; the potential set of user-defined custom folders is large and dynamic. Existing filter grammars would require enumerating the names of each of the custom folders to be synchronized. The present invention enables an end user to internally select on the client side which folders and e-mail items to synchronize without requiring any modification to the server side synchronization mechanism. The values of the selectivity attributes are stored with the respective folders' metadata and may be updated by the end user such as when files are created or renamed, either on the client or enterprise server side.

Referring now to FIG. 2A, there is illustrated a high-level block diagram depicting a hierarchical e-mail data structure 25 in which synchronization may be performed in accordance with the invention. In the depicted embodiment, e-mail data structure 25 is illustrated as a three-level hierarchy in which the top level comprises an entire e-mail application 22 such as may be installed and loaded on a client side data processing system. The second level comprises multiple e-mail folders, Folder A 24, Folder B 26, and Folder C 28, and the bottom level comprises e-mail objects 32, 34, and 36 contained within folders 24, 26, and 28, respectively. Referring to FIG. 2B in conjunction with FIG. 2A, there is illustrated one of the possible implementations of the synchronization filtering mechanisms of the present invention. Namely, FIG. 2B illustrates hierarchically embedded meta-information within an XML representation of data structure 25 and used for synchronization of e-mail data objects in accordance with the invention.

The XML representation in FIG. 2B contains the hierarchically arranged e-mail data objects including the e-mail application 22 containing multiple e-mail folders 24, 26, and 28, which in turn contain e-mail objects 32, 34, and 36, respectively. As shown in FIG. 2B, top-level object 22 contains meta-filtering information specifying that only “high priority” e-mail data items are to be synchronized. On the second level, Folder A 24 and Folder C 28 have meta-filtering information directing that their respective contained e-mails 32 and 36 are not to be synchronized. The end result in the embodiment depicted in FIGS. 2A and 2B is that under the given meta-information embedded filtering parameters, only high priority e-mails in Folder B 26 would be synchronized responsive to the e-mail application 22 being specified by a synchronization request such as within a command line argument or otherwise.

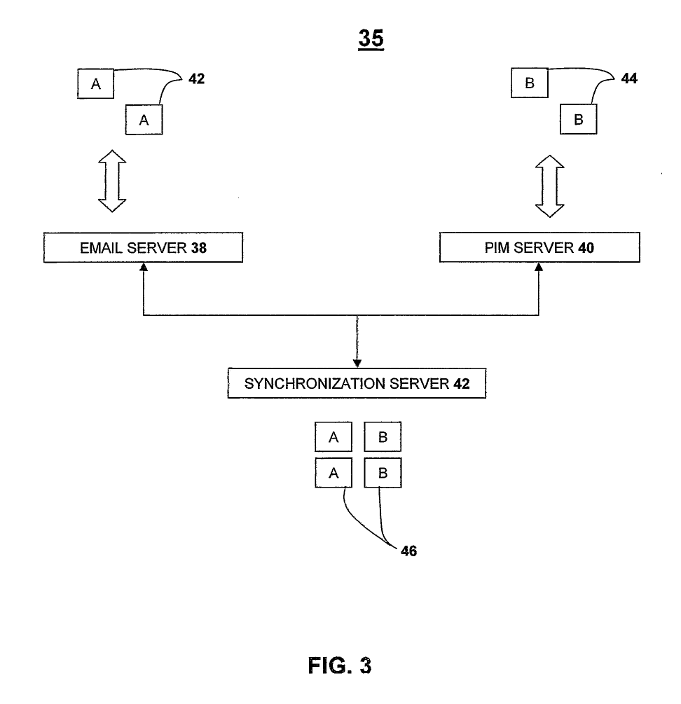

Additionally, since the meta-filtering-information is associated with the synchronization objects themselves, processing subsets of the full data set or merging multiple data sets is possible. For example, FIG. 3 is a high-level block diagram depicting a synchronization environment 35 in which a common synchronization server provides data synchronization functions for disparate data types received from distinct servers. Synchronization environment 35 includes a synchronization server 42, as well as two enterprise servers, an e-mail server 38 and a PIM server 40. E-mail server 38 is the entry point of data items 42 relating to the supported e-mail applications and PIM server 40 is the entry point of data items 44 relating to the support PIM applications. Synchronization server 42 performs synchronization of data stored and managed by e-mail server 38 and PIM server 40 such that it contains the superset of all data items 46. In this configuration, synchronization may be performed among any of the three servers and be able to properly filter the data it held. This is due to the fact that the filtering meta-information allows each of the synchronization objects (e.g., any one or more of data items 42 and/or 44) carry the filter data applying to itself and also the filter data for those objects for which it is a hierarchical parent. Extending the depicted example of three servers to a larger set of servers and millions of data items, it can be seen how the present invention allows for substantially improved scalability and robustness.

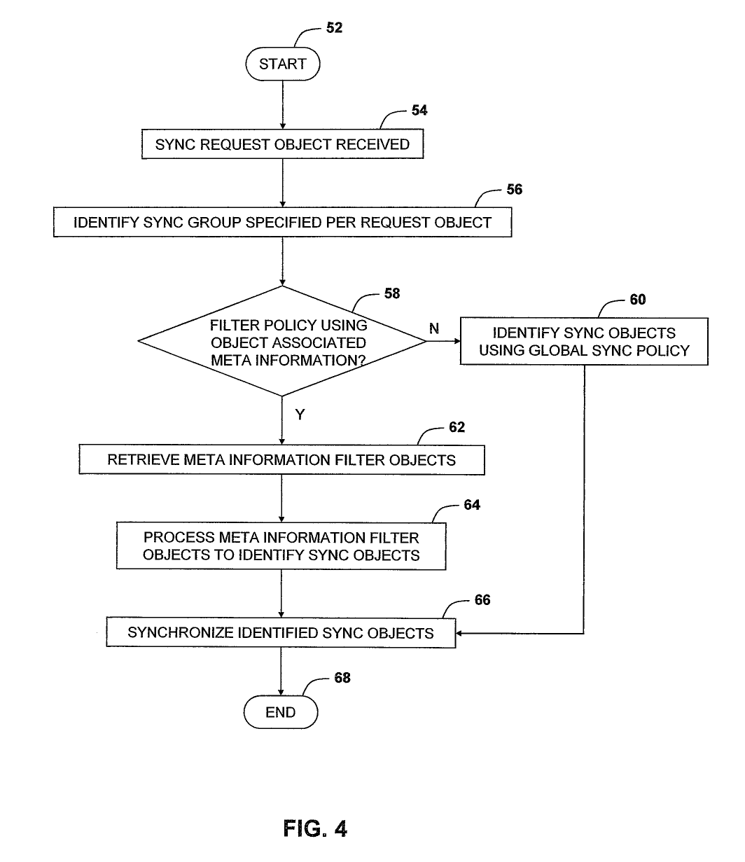

With reference to FIG. 4, there is depicted a high-level flow diagram illustrating steps performed during synchronization of data objects using synchronization filter meta-information in accordance with the invention. The process begins as shown at steps 52 and 54 with a synchronization request being received. Given that the present invention may be applied bi-directionally, the synchronization object may be received on either a client or server side. The received synchronization request preferably specifies the one or more sets of data items to be synchronized as illustrated at step 56.

As illustrated at steps 58 and 60, if the filter mechanism implements a global filter mechanism that does not account for filtering data maintained as part of the meta-information of the target data items, the data items to be synchronized are identified using the global filter policy and the identified items are synchronized (step 66). If, the filter mechanism does account for embedded meta-information associated with the respective data items, the meta-information is read (step 62) and processed to select which data items in the set(s) specified by the request will be synchronized (step 64). The selected data items are then synchronized (step 66) and the synchronization process ends as shown at step 68.

While the invention has been particularly shown and described with reference to a preferred embodiment, it will be understood by those skilled in the art that various changes in form and detail may be made therein without departing from the spirit and scope of the invention. These alternate implementations all fall within the scope of the invention.

What is claimed is:

1. A method for synchronizing data items in a data processing system, said method comprising:
receiving a synchronization request that specifies a set of data items that are subject to synchronization;
identifying the set of data items subject to synchronization from said synchronization request;
commencing a synchronization cycle of the identified set of data items, said synchronization cycle including:
processing meta-information associated with the identified set of data items;
determining synchronization filter parameters from said processed meta-information; and
selecting data items to be synchronized in accordance with said determined synchronization filter parameters.

2. The method of claim 1, wherein the set of data items specified by said synchronization request is maintained by a client application, said synchronization cycle further including synchronizing the selected data items with corresponding data items stored by a server e-mail application.

3. The method of claim 1, further comprising:
utilizing said client application to generate and send a synchronization request to a server; and
performing said synchronization cycle utilizing said server.

4. The method of claim 1, wherein the processed meta-information is stored in a relational database or in a backend data stored.

5. The method of claim 4, wherein the set of data items subject to synchronization are managed using a hierarchical data structure, and wherein the processed meta-information is associated with the set of data items in conformity with said hierarchical data structure.

6. The method of claim 1, wherein the synchronization request is generated by a daemon-initiated process or manually entered as a command line request.

7. A tangible computer-readable storage medium having stored thereon computer-executable instructions for synchronizing data items in a data processing system, said computer-executable instructions adapted for performing a method comprising:
receiving a synchronization request that specifies a set of data items that are subject to synchronization;
identifying the set of data items subject to synchronization from said synchronization request;
commencing a synchronization cycle of the identified set of data items, said synchronization cycle including:
processing meta-information associated with the identified set of data items;
determining synchronization filter parameters from said processed meta-information; and
selecting data items to be synchronized in accordance with said determined synchronization filter parameters.

8. The tangible computer-readable storage medium of claim 7, wherein the set of data items specified by said synchronization request is maintained by a client e-mail application, said synchronization cycle further including synchronizing the selected data items with corresponding data items stored by a server e-mail application.

9. The tangible computer-readable storage medium of claim 7, wherein the processed meta-information is stored in a relational database or in a backend data stored.

10. The tangible computer-readable storage medium of claim 9, wherein the set of data items subject to synchronization are managed using a hierarchical data structure, and wherein the processed meta-information is associated with the set of data items in conformity with said hierarchical data structure.

11. The tangible computer-readable storage medium of claim 7, wherein the synchronization request is generated by a daemon-initiated process or manually entered as a command line request.
